(19) United States
(12) Patent Application Publication
(10) Pub. No.: US 2007/0024447 A1
(43) Pub. Date: Feb. 1, 2007

(54) Radio energy propagation channel network for detecting RFID tagged items

(76) Inventors: Walter D. Burnside, Dublin, OH (US); Chang-Fa Yang, Taipei City (TW); Teh-Hong Lee, Dublin, OH (US)

Correspondence Address: Howard Chen, Esq.;Preston Gates & Ellis LLP, Suite 1700, 55 Second Street, San Francisco, CA, 94150, US

(21) Appl. No.: 11/443,991

(22) Filed: May 31, 2006

(30) Foreign Application Priority Data
Jul. 29, 2005 (TW) 94125975

(51) Int. Cl. G08B 13/14

(52) U.S. Cl. 340/572.1

(57) ABSTRACT

This invention provides a radio frequency identification (RFID) system comprising at least one reader module for radiating RF energy, a plurality of predetermined containers tagged by a plurality of RFID tags for receiving the radiated RF energy, wherein one or more containers are equipped with at least one conducting surface associated with at least one container side piece thereof so that when the plurality of the predetermined containers form a pile, an RF energy propagation channel network is formed comprising one or more propagation channels constructed by at least two conducting surfaces between two containers for confining and propagating the RF energy there-between.

### CROSS REFERENCE

The present application claims the foreign priority of Taiwan Application Serial Number, 94125975 which was filed on Jul. 29, 2005.

### BACKGROUND

The present invention relates generally to radio energy transmission, and more specifically related to transporting radio energy through a set of containers for radio frequency identification systems.

A radio frequency identification (RFID) system uses RF transmission to identify, categorize, locate and track elements. It is made up of two primary components: a transponder or the RFID tag and a reader. The tag is a device that generates electrical signals or pulses interpreted by the reader. The reader is a transmitter/receiver combination (transceiver) that activates and reads the identification signals from the transponder.

RFID tags are considered to be intelligent bar codes that can communicate with a networked system to track every element associated with a designated tag. RFID tags will communicate with an electronic reader that will detect the “tagged” element and further connects to a large network that will send information on the elements to interested parties such as retailer and product manufacturers. For example, the tag can be programmed to broadcast a specific stream of data denoting identity such as serial and model numbers, price, inventory code and date. Therefore, the RFID tags are expected to be widely used in the wholesale, distribution and retail businesses.

The RFID tag is an integrated circuit that is coupled with an antenna to receive incoming RFID radiated power and to transmit data. The circuit contains memory that stores the identification code and other pertinent data to be transmitted when the microprocessor is activated or interrogated using radio energy from the reader. RFID systems can be further categorized by their tag characteristics being active or passive. Active tags include a power source such as a battery. The battery may be built-in or connected to the tag. Advantages of an active tag are a longer read range and a reduced reader power requirement. Passive tags have no on-board power source, but do have a chip and an antenna. Thus, they are powered electromagnetically by the reader radiated signal. The advantages of passive tags are that they cost less, are considerably smaller and lighter than the active tag, and their lifetime is virtually unlimited. However, they have a short read range, and a higher powered reader is required to interrogate or activate them.

Compared to passive bar code based labels, the RFID tags are much more “active”. There are traditionally two types of RFID tags, the inductively-coupled RFID tags and the electromagnetic-coupled RFID tags. Inductive RFID tags are powered by the magnetic field generated by the reader. After the tag picks up the magnetic energy, the tag communicates with the reader. The tag then modulates the magnetic field in order to retrieve and transmit data back to the reader. Data is transmitted back to the reader, which further connects to a computer network for processing the data received.

Electromagnetic-coupled RFID tags do away with the metal coil in that they use the incoming RF signal to charge a capacitor. An electromagnetic-coupled tag has a microprocessor, which can also store certain bits of information, which would allow for trillions of unique numbers that can be assigned to products or elements associated with such tags. There is an antenna component that is built into the tag using, for example, a conductive carbon ink printing process. The conductive carbon ink may be printed to a paper substrate or thin film through conventional printing means. The microprocessor is attached to the printed electrodes on the back of the label, creating a disposable tag that can be integrated on conventional product labels.

The disadvantage to the inductively-coupled tag is that it has a very limited range. The electromagnetic-coupled tag can function at a much longer distance. However, in order for a system of multiple communicating tags in complicated environments to work, the range still needs to be boosted. Companies have developed RFID tags that tend to meet these needs, but they are more expensive than what is ultimately needed in the marketplace.

A reader also contains an RF antenna, transceiver and a micro-processor. The transceiver sends activation signals to and receives identification data from the tag. The antenna may be enclosed with the reader or located outside the reader as a separate piece. The reader may be either a hand-held or a stationary component that checks and decodes the data it receives.

In order for an RFID system to work, each product or element associated with a tag may have to be given a unique product number. MIT's Auto-ID Center is working on an Electronic Product Code (EPC) identifier that could replace the UPC. Every tag could have such an identifier containing 96 bits of information, including the product manufacturer, product name and a 40-bit serial number. Using this system, an RFID tag would communicate with a network, called the Object Naming Service, which would retrieve information about a product and then direct information to the manufacturer's computers.

One of the biggest problems facing RFID applications is multiple item scanning. When several tags are read at the same time and these tagged items are close together, one tag's transmission interferes with that of another. In such an autonomous wireless environment with multiple items that are being interrogated and responding at the same time, the resulting signal interference can cause fading problems. For example, when pluralities of containers are provided in a pile for scanning, some of these containers may be containing metal structures that will tend to block an incoming RF signal. Or, the containers may hold materials that cause multi-path of signals or even contain material that acts as electromagnetic absorber.

In most wireless systems with presented interferences, the quality of a desired signal is improved by increasing its signal-to-noise ratio so that the specific signal can be properly decoded. In the multiple articles environment, due to the rich interference, an increased reader signal level will tend to only make the problem worse by exciting more tags and enhancing the multi-path situation.

Therefore, desirable in the art of RFID world is an improved system for identifiably reading or detecting items tagged by RFID tags in a multiple article environment.

### SUMMARY

This invention provides a radio frequency identification (RFID) system comprising at least one reader module for radiating RF energy, a plurality of predetermined containers tagged by a plurality of RFID tags for receiving the radiated RF energy, wherein one or more containers are equipped with at least one conducting surface associated with at least one container side piece thereof so that when the plurality of the predetermined containers form a pile, an RF energy propagation channel network is formed comprising one or more propagation channels constructed by at least two conducting surfaces between two containers for confining and propagating the RF energy there between.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 presents two containers with at least one RF energy propagation channel integrated therein according to one embodiment of the present invention.

FIG. 2 presents two containers with at least one RF energy propagation channel integrated therein according to another embodiment of the present invention.

FIG. 3 presents containers of different sizes with an RF energy propagation channel network integrated therein according to another embodiment of the present invention.

FIG. 4 presents a portion of a container pile with one or more side pieces of selected containers covered by conducting surfaces according to another embodiment of the present invention.

### DESCRIPTION

The present invention provides a radio energy propagation channel network to define predetermined propagation channels that allow sufficient energy to be received by the RFID tag antenna.

An RFID system is basically a wireless system that is used to identify RFID-tagged items based on the specific tag information recorded on the RFID tags. Each tag is activated by an interrogating signal transmitted wirelessly through an RF frequency band that charges up an internal capacitor within the RFID tag. As this capacitor is charged by the incoming RF signal, the tag's IC input impedance is modulated with the recorded information. This modulates the backscatter return from the tag antenna so that an interrogating source such as a reader module can determine the needed response. This information is then used by the reader to define the disposition of the tagged items.

As well-known in the industry, one major problem that still remains in RFID applications is the very complex propagation path in that the reader desires to communicate with tagged items such as containers that are surrounded not by free space, but by other items or containers. If the surrounding containers hold metal structures, they will tend to block the incoming RF signal from reaching certain containers that are surrounded by them. In other cases, the surrounding containers may hold materials that cause tremendous multi-path effects of a very complex nature or even contain materials that act as electromagnetic absorber that greatly attenuates the incoming RFID signal. Therefore, the wireless link between the reader and the desired tagged items is broken or nearly-broken if an improved RF signal propagation path is not better-defined that will allow sufficient energy to be received by the RFID tagged items, or more specifically, by the tag antenna.

For illustration purposes, the present invention is illustrated in the context of providing the RF signal propagation paths in a multi-container environment in which a plurality of containers are placed together in a pile together. Since the containers are made of low-loss dielectric material such as cardboard, the paper-based cardboard acts very much like free space in that it causes very little attenuation of the RF signal at the RFID frequencies. Since the containers are “piled” up together, the predetermined thicknesses of the surfaces of the containers naturally create space between these containers.

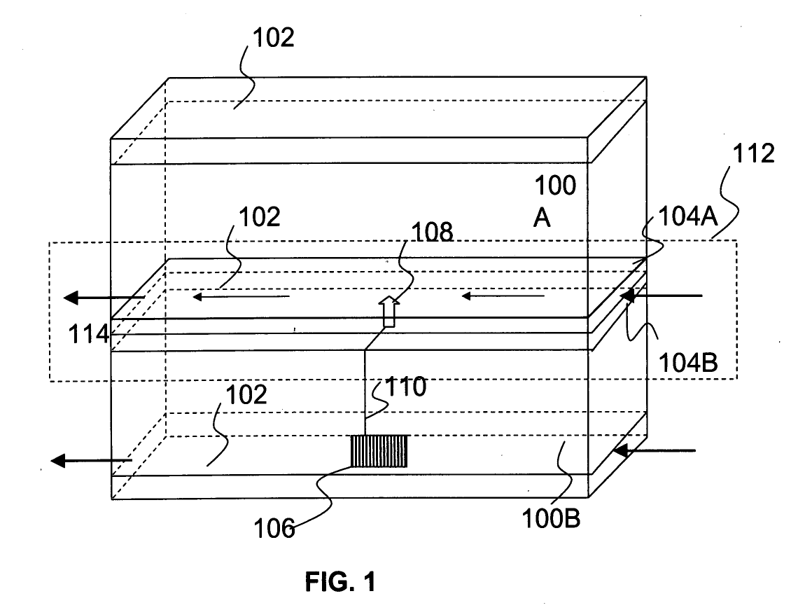

FIG. 1 illustrates two containers in a pile of containers with an enhanced energy propagation channel created according to one embodiment of the present invention. In this illustration, only two containers 100A and 100B are shown. For each container, one or more energy propagation channels 102 can be constructed by two surfaces 104A and 104B of conducting materials. Although only the propagation channels of one direction are shown in this figure, it is understood that such propagation channels can be constructed on all surfaces of the container so that the container can be “wrapped” all around by such propagation channels to improve energy transmission. More importantly, when the containers are piled together, such propagation channels automatically form a network themselves. The radio energy propagates through the propagation channel network is designed to be confined therein. The arrows in this figure illustrate a possible propagation path that the radio energy travels. It is further understood that the container is tagged by an RFID tag 106, which can be put on any predetermined location on the container and is expected to receive the radio energy and respond to the reader. The RFID tag 106 is connected to its antenna 108 through a signal connection 110.

Referring to an area confined in the rectangular box 112, this is where two containers border on each other. It is assumed that the interior paper-based surfaces of every container have additional conducting surface placed or coated thereon. The RF energy propagation channel is formed by having the conducting surface 104A from the container on the top and the conducting surface 104B from the bottom container with line 114 showing the seam between the two containers. This channel will direct the energy to flow along the cardboard as indicated by the arrows. A plurality of this kind of channel forms an energy propagation channel network. As such, the desired RF energy flows through the propagation channel network taking a path that is independent of the contents of the containers. It is understood that the conducting surface can be placed on or otherwise associated with the interior or exterior surface of the container. In fact, the conducting surface can be associated with the container side piece by being embedded between the interior and exterior surfaces of the container. Further, this can be a broadband solution because the propagation path follows a guided structure that does not have a lower frequency cutoff provided that the incident signal is polarized normal to the boundaries of the channel. The RFID tag; antenna 108, if properly designed, will receive sufficient signal-to-noise performance to allow it to function properly even in very complex pile configurations.

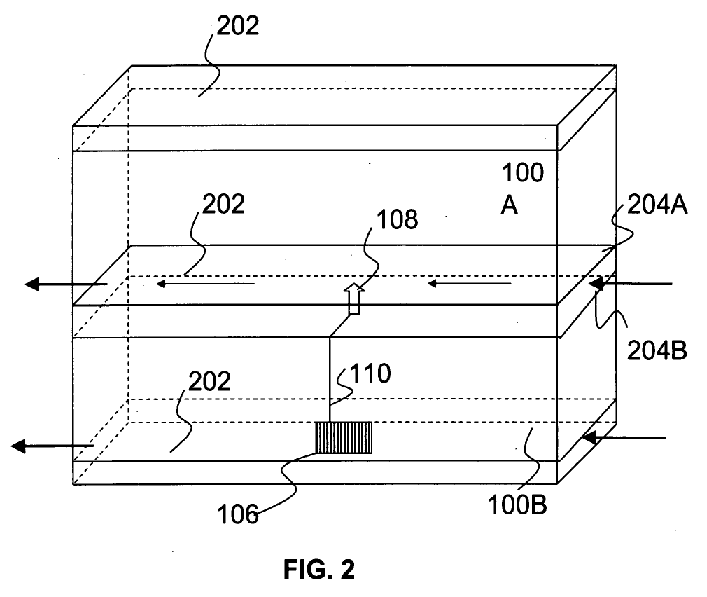

FIG. 2 illustrates an enhanced RF energy propagation channel network provided by a specially-designed spacer module according to another embodiment of the present invention. In this configuration, a spacer module 202 with parallel metalized surfaces 204A and 204B is placed between the containers in order to greatly improve the RF energy propagation, or signal-to-noise ratio of RFID signals. Between the surfaces, the spacer module can have a predetermined spacer material such as foam, cardboard or any low RF loss material. The spacer module can be mounted inside or outside the containers depending on the application. The metalized surfaces of the spacers can be added using simple printing, bonding or any other concept that places conducting structures around the spacer's core material. When having the spacer module, it is understood that the spacer module should be placed in such a way that the spacer material is not completely surrounded by conducting surfaces. Since the spacer material has six surfaces that can be exposed, two of them are already conducting surfaces, and if all other four are “sealed” by conducting surfaces, no RF energy can travel within the spacer module.

The RF energy propagation channels formed between the containers can be of various configurations. For example, even if the containers are of different sizes, or the containers are arbitrarily located or positioned, or even filled with any possible contents, the energy propagation channel network can still be formed automatically through the “piling” of the containers, and the parallel or substantially parallel surfaces of each segment of the energy propagation channels causes the energy to flow in the propagation paths that are isolated from the contents.

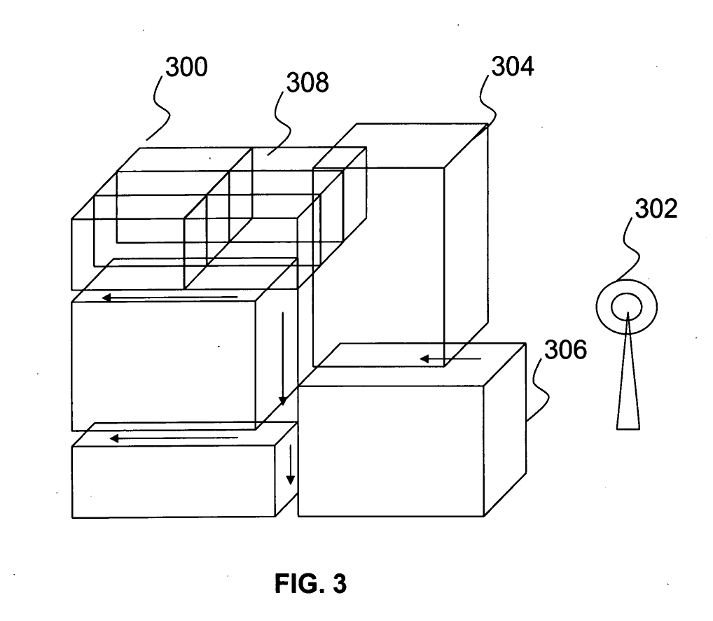

FIG. 3 illustrates a container pile 300 with multiple containers according to one embodiment of the present invention. In this configuration, the pile 300 receives RF energy from an energy source such as the reader module 302. The radiation of the RF energy is passed through the “gaps” or the energy propagation channel network formed between the containers. The various containers 304-308 in the pile can be of different sizes. The surface structures of these channels (as indicated by the arrows) allow the RF energy to flow in multiple directions and permeate various parts of the pile 300. The distances between these two surfaces may vary depending on the various thicknesses of the cardboard materials forming the containers, or depending on the relative random spaces created while stacking the containers to form the pile. It is further understood that since the containers used in the commercial world today are largely of a rectangular shape, the examples provided above use two substantially parallel surfaces for constructing the RF energy propagation channel. However, it is understood that the surfaces do not have to be parallel to each other as long as they can define a space between them for allowing the RF energy to travel there-through.

The two conducting surfaces forming the energy propagation channel can be associated with one side piece of a container. As opposed to the example illustrated in FIG. 2, another embodiment of the present invention has the entire energy propagation channel formed by two conducting surfaces constructed with one side piece. For example, a first conducting surface may be coated on the interior surface and a second conducting surface is coated on the exterior surface of one of the six sides of the container. This configuration provides an independent channel formed on the container whose use does not depend on having another conducting surface provided by another container. Further, as indicated above, not every container side piece has to be coated or otherwise equipped with such a conducting surface. Therefore, the energy propagation channel may be constructed by one conducting surface from one container and more than one conducting surface from another container as long as they provide a somewhat contiguous path for the RF energy.

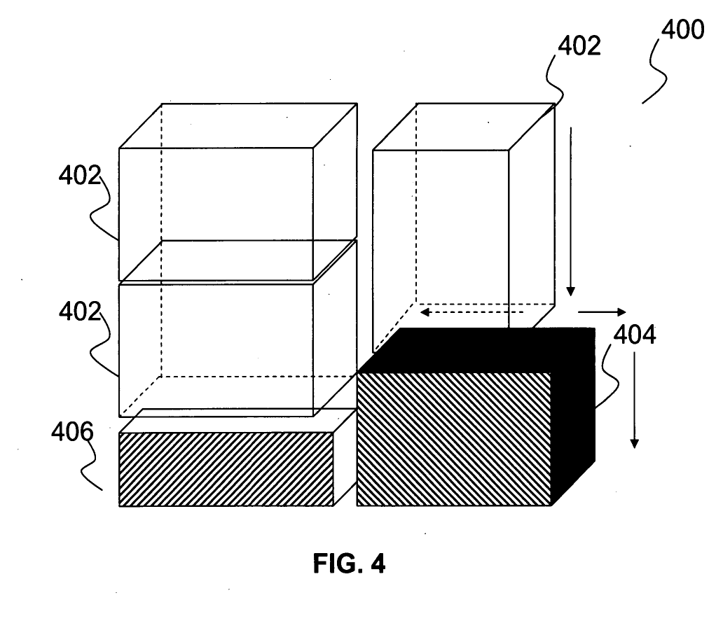

FIG. 4 presents a portion of a container pile with one or more container side pieces of selected containers covered by conducting surfaces according to another embodiment of the present invention. This configuration illustrates that not all the containers in a pile need to be “sealed” with conducting surfaces. An RF energy propagation channel network can be used in a pile with some containers together in operation with other containers having different configurations, i.e., containers having none of its surfaces or having fewer than all six side pieces covered by conducting surfaces. What type of container configuration is needed really depends on the content of the containers. For example, in this pile of containers 400, it is assumed that containers 402 contain non-RF absorbing contents such as plastic materials. In this case, none of the containers needs to be a part of the RF energy propagation channel network as the RF energy can penetrate these containers very successfully. On the other hand, container 404 may have purely metal content that will severely restrict the RF energy and block its further propagation to reach other containers in the pile. In this case, the container 404 has all six side pieces covered by conducting surfaces so that the metal content is completely “sealed” within the container and the RF energy travels around the container (as exemplified by the arrows) without being encumbered in any way. Container 406 has only its front piece being covered by a conducting surface with other five surfaces unequipped with any particular coating. Since the adjacent container 404 has constrained the energy absorbing content from interfering with the energy propagation, the container 406 can be placed in a container just like those of 402 without any conducting surface. However, the container 406 does have at least one side piece that has a covering conducting surface material, if it does not carry energy absorbing content. This is done so for better operation of the antenna since the conducting surface can be viewed as a ground plane, which is coupled together with an antenna of the RFID tag. It is also understood that this ground plane does not have to cover the full container surface, as it functions just well by having the size of a predetermined portion of the surface.

This pile of containers illustrates that although the energy propagation channel network can be formed by containers having all side pieces covered by conducting materials, it can still work with containers of other configurations. Packaging companies can decide what type of containers should be used based on the determination of the content carried by the containers. This also illustrates that the energy propagation channel network should be loosely defined and does not require the RF energy to travel between two closely placed conducting surfaces. For instance, in a pile of containers, there can be only one container that has all its side pieces associated with conducting surfaces, and it should be recognized that an RF energy propagation channel network exists as the RF energy gets “reflected” from the surfaces and penetrates other containers in the pile.

As illustrated above, the surfaces are fixed at a relatively-small distance apart, even though a low-loss spacer may be used to allow more RFID radiated energy to be received by the tag antenna. In order to provide sufficient energy through this small spacing, the RF signals propagating therein will be polarized normal to the surfaces in order to satisfy the fundamental boundary conditions. Thus, this normal polarized signal will provide the best result.

The above illustration provides many different embodiments or embodiments for implementing different features of this invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A radio frequency identification (RFID) system comprising:
at least one reader module for radiating RF energy; and
a plurality of predetermined containers tagged by a plurality of RFID tags for receiving the radiated RF energy,
wherein one or more containers are equipped with at least one conducting surface associated with at least one container side piece so that when the plurality of the predetermined containers form a pile, an RF energy propagation channel network is formed comprising one or more propagation channels constructed by at least two conducting surfaces for confining and propagating the RF energy there-between.

2. The RFID system of claim 1, wherein the conducting surface is placed on one or more interior or exterior surfaces of one or more containers.

3. The RFID system of claim 1, wherein the conducting surface is coated on the interior or exterior surfaces of the container side piece.

4. The RFID system of claim 1, wherein the conducting surface is embedded between an interior and an exterior surface of the container side piece.

5. The RFID system of claim 1, wherein the conducting surface is substantially parallel to the container side piece.

6. The RFID system of claim 1, wherein the energy propagation channel is formed by a spacer module placed between two containers with at least two conducting surfaces with a predetermined low-loss spacer material filled there-between.

7. The RFID system of claim 6, wherein the spacer material is not completely surrounded by conducting surfaces.

8. The RFID system of claim 1, wherein the energy propagation channel is formed by a first conducting surface of a first container and a second conducting surface of a second container.

9. The RFID system of claim 1, wherein the energy propagation channel is formed by a first conducting surface and a second conducting surface associated with one side piece of a container.

10. The RFID system of claim 1, wherein at least one container has all container side pieces associated with conducting surfaces for blocking content contained therein from absorbing the RF energy.

11. The RFID system of claim 1, wherein at least one conducting surface associated with the container functions as a ground plane coupled to an antenna of the RFID tag.

12. The RFID system of claim 1, wherein the pile of the containers further includes containers with no conducting surface associated therewith.

13. A packaging container used with a radio frequency identification (RFID) system comprising:
at least one container side piece associated with a conducting surface placed substantially parallel to either surface of the container side piece;
at least one RFID tag attached to one of the container side pieces; and
at least one antenna attached to one of the container side pieces and operable with the RFID tag,
wherein when a plurality of the containers form a pile, at least two conducting surfaces construct at least one propagation channel for confining and propagating RF energy there-between.

14. The container of claim 13, wherein the conducting surface is coated on the interior or exterior surfaces of the container side piece.

15. The container of claim 13, wherein the conducting surface is embedded between an interior and an exterior surface of the container side piece.

16. The container of claim 13, wherein the container side piece having at least two conducting surfaces substantially parallel to each other.

17. The container of claim 13, further comprising a spacer module including at least two conducting surfaces with a predetermined low-loss spacer material filled there-between.

18. The container of claim 13, wherein all container side pieces are associated with conducting surfaces for blocking content contained therein from absorbing an RF energy received by the antenna.

19. The container of claim 13, wherein at least one conducting surface associated with the container functions as a ground plane coupled to the antenna.

20. A packaging container used with a radio frequency identification (RFID) system comprising:
each container side piece associated with a conducting surface placed substantially parallel to either surface of the container side piece for blocking content contained in the container from absorbing an RF energy directed toward the container;
at least one RFID tag attached to one of the container side pieces; and
at least one antenna attached to one of the container side pieces and operable with the RFID tag for receiving the RF energy.

21. The container of claim 20, wherein the conducting surface is coated on the interior or exterior surfaces of the container side piece.

22. The container of claim 20, wherein the conducting surface is embedded between an interior and an exterior surface of the container side piece.

23. The container of claim 20, wherein the container side piece has at least two conducting surfaces substantially parallel to each other.

24. The container of claim 20, further comprising a spacer module including at least two conducting surfaces with a predetermined low-loss spacer material filled there-between.

25. The container of claim 20, wherein when a plurality of the containers form a pile, at least two conducting surfaces from one or two containers construct at least one propagation channel for confining and propagating the RF energy there-between to be received by the antenna that is normal to a direction of the propagated RF energy.
